(19) United States
(12) Patent Application Publication
(10) Pub. No.: US 2013/0081826 A1
(43) Pub. Date: Apr. 4, 2013

(54) IN-SITU GENERATED BUFFER SYSTEM

(71) Applicant: Saudi Arabian Oil Company, Dhahran (SA)

(72) Inventors: Mohammed H. Al-Khaldi, Dhahran (SA); Masalli A. Al-Otaibi, Dhahran (SA); P. P. Najeeb, Dhahran (SA)

(73) Assignee: Saudi Arabian Oil Company, Dhahran (SA)

(21) Appl. No.: 13/630,238

(22) Filed: Sep. 28, 2012

Related U.S. Application Data
(60) Provisional application No. 61/540,893, filed on Sep. 29, 2011.

(51) Int. Cl. C09K 8/52; E21B 29/02

(52) U.S. Cl. 166/376; 507/267

(57) ABSTRACT

An aqueous buffered treatment solution for removing mud cake from a well bore treatment site is made by inducing an elevated temperature in an aqueous pre-buffer solution. The aqueous pre-buffer solution is made of an acid precursor that hydrolyzes into a treatment acid, a conjugate base salt that forms the conjugate base of the acid, and an aqueous fluid. Inducing the elevated temperature forms the treatment acid. The treatment acid is operable to remove mud cake.
A method for removing a portion of mud cake from a treatment site using an aqueous buffered treatment solution to establish flow-back includes the step of introducing the aqueous pre-buffer solution to the treatment site. The introduction occurs such that the pre-buffer solution fluidly contacts the mud cake. The hydrocarbon-bearing formation induces the elevated temperature in the solution. Reaction between treatment acid and the acid-reactive constituents removes a portion of the mud cake.

### CROSS-REFERENCE TO RELATED PATENT APPLICATIONS

This application claims priority from U.S. Provisional Application No. 61/540,893, filed Sep. 29, 2011. For purposes of United States patent practice, this application incorporates the contents of the Provisional Application by reference in its entirety.

### BACKGROUND OF THE INVENTION

1. Field of the Invention

The field of invention relates to an aqueous acid-base buffer system and method of use. More specifically, the field relates to the aqueous acid-base buffering system and its method of use in producing hydrocarbons from a well bore.

2. Description of the Related Art

A multilateral well is a well bore that branches from a centralized vertical or horizontal well bore into more than one vertical, deviated or horizontal section. In such a configuration, the multilateral well is operable to produce hydrocarbon fluids from more than one location simultaneously along several fluid flow pathways. An example includes multilateral well servicing different hydrocarbon-bearing formations at different depths, where each depth has a dedicated horizontal run or leg following the strata from a central vertical well bore. Some refer to this well bore configuration as a “multi-tier” well. Another example includes a horizontal well bore fanning out into multiple horizontal branches from a single horizontal well header.

In drilling operations that use water, a water-based mud cake, which is an amalgamated solid, coats the well bore wall surface. In some instances, the application of water-based mud cake occurs to prevent lost returns. Mud cake acts to bridge across fluid-productive areas of the well bore wall to clog up fluid channels that are operable to produce formation fluids. Mud cake restricts fluid production from the productive face of the well bore. Operators use systems designed to remove mud cake to establish a desired level of hydrocarbon fluid flow during completions operations.

Water-based mud cake contains carbonates and silicates. In some mud cake formulations, the carbonates and silicates are polymer or modified organic-coated materials. Acid systems, including hydrochloric/hydrofluoric acid mixtures, and enzyme systems are effective in removing water-based mud cake. Acid systems target inorganic components of water-based mud cakes, including calcium carbonate, bentonites and other silicates. Enzyme systems focus on disassembling organic constituents of mud cake products, including polymer flocculants and starch-based derivatives, including hydroxylethyl cellulose (HEC). In some treatment systems, both types are used simultaneously.

There are significant challenges to removing water-based mud cake from a productive well bore face at multiple sites in a multilateral well. Operators often use coiled tubing to apply mud cake removal systems. Positioning the coiled tubing for application to sites within the well bore is difficult. This results in significant idle rig time (that is, not drilling) during mud cake treatment. Coiled tubing not positioned accurately at treatment sites results in applying treatment to the wrong locations in the well bore. Acids applied to the wrong location can damage casing, cement and even parts of the productive well bore face. In applying enzymes to the wrong location, these systems are expensive and misapplication results in a total loss.

Deploying acid and enzyme systems at the end of the drilling phase (before completions) through the internal fluid conduit of a drill pipe is an alternative method. Although this solves the issue of direct and accurate application, the mud cake removal systems are often “too effective” for multilateral well bore use. If the time interval between application of the treatment system at a first treatment site and flow-back from that site is too short, premature well bore fluid loss and possibly hydrocarbon influx into the well bore can occur while still treating other portions of the well bore. Both situations require immediate intervention. Emergency intervention can result in the application of well-damaging chemicals to stop the fluid loss or influx.

Another alternative method is to generate an acid system in-situ at the treatment site; however, historically these systems do not provide adequate delay before effectively removing mud cake. The time interval between application of the acid generation system and establishing flow-back is too short to permit continued drilling or completions operations in a multilateral well. Sometimes these systems also exhibit unpredictable behavior from unexpected reactions of materials in the well bore.

### SUMMARY OF THE INVENTION

The invention includes an aqueous buffered treatment solution useful for removing mud cake. The aqueous pre-buffer solution is made by combining an acid precursor operable to undergo hydrolysis into a treatment acid at the elevated temperature, a conjugate base salt operable to disassociate into a conjugate base for the treatment acid, and a base aqueous fluid. Forming the aqueous buffered treatment solution includes the step of inducing an elevated temperature in the aqueous pre-buffer solution, causing the acid precursor to undergo hydrolysis and form the treatment acid. The treatment acid is operable to remove mud cake from the well bore treatment site.

The invention includes an aqueous pre-buffer solution useful for treating mud cake. The aqueous pre-buffer solution is made from the acid precursor operable to undergo hydrolysis into the treatment acid at an elevated temperature, the conjugate base salt operable to disassociate into the conjugate base for the treatment acid, and the base aqueous fluid. Upon inducing an elevated temperature such that the acid precursor undergoes hydrolysis and forms a treatment acid the aqueous pre-buffer solution forms an aqueous buffered treatment solution.

The invention includes a method for removing a portion of mud cake from a treatment site using an aqueous buffered treatment solution to establish flow-back. The method includes the step of combining an acid precursor operable to undergo hydrolysis into a treatment acid at an elevated temperature, a conjugate base salt operable to disassociate into a conjugate base for the treatment acid, and a base aqueous fluid to form the aqueous pre-buffer solution. The aqueous pre-buffer solution has a molar value ratio and a treatment delay value. The method includes the step of introducing the aqueous pre-buffer solution to the treatment site. The introduction occurs such that the pre-buffer solution fluidly contacts the mud cake.

The hydrocarbon-bearing formation induces an elevated temperature in the introduced aqueous pre-buffer solution such that the acid precursor undergoes hydrolysis into the treatment acid. The mud cake at the treatment site includes acid-reactive constituents that react with the treatment acid. Reaction with the acid-reactive constituents removes a portion of the mud cake and establishes flow-back.

The invention includes a method for removing a portion of mud cake from more than one treatment site in a well bore servicing a hydrocarbon-bearing formation using more than one aqueous buffered treatment solution to establish flow-back. The method includes the step of combining a first acid precursor operable to undergo hydrolysis into a first treatment acid at an elevated temperature, a first conjugate base salt operable to disassociate into a first conjugate base for the first treatment acid, and a first base aqueous fluid to form the first aqueous pre-buffer solution. The first aqueous pre-buffer solution has a first molar value ratio and a first treatment delay value. The method includes the step of combining a second acid precursor operable to undergo hydrolysis into a second treatment acid at an elevated temperature, a second conjugate base salt operable to disassociate into a second conjugate base for the second treatment acid, and a second base aqueous fluid to form the second aqueous pre-buffer solution. The second aqueous pre-buffer solution has a second molar value ratio and a second treatment delay value. The method includes the step of introducing the first aqueous pre-buffer solution to a first treatment site such that the first pre-buffer solution fluidly contacts the mud cake at the first treatment site. The method includes the step of introducing the second aqueous pre-buffer solution to a second treatment site such that the second pre-buffer solution fluidly contacts the mud cake at the second treatment site. Introduction to the first and second treatment sites does not occur at the same time.

An embodiment includes where the treatment acid is a carboxylic acid and the conjugate base is a carboxylate ion for the treatment acid. An embodiment includes of the method where the treatment acid is formic acid and the conjugate base is formate base. An embodiment includes where the acid precursor is ethyl formate and the conjugate base salt is potassium formate. An embodiment includes where the aqueous pre-buffer solution has an amount of conjugate base salt in a range of from about 2 weight percent to about 4 weight percent of the total weight of the solution. An embodiment includes where the aqueous buffered treatment solution removes at least 50 weight percent of the mud cake at a treatment site in a well bore in no less time than 10 hours after introduction of the aqueous pre-buffer solution to the treatment site.

An embodiment of the method includes introducing the aqueous pre-buffer solution occurs at a time of introduction such that flow-back does not occur until after a future point in time. An embodiment of the method includes introducing the aqueous pre-buffer solution such that at a time of introduction flow-back occurs during a future time interval.

The aqueous buffered treatment solution delays the effect of the acid reaction with the mud cake at a treatment site. The retardation of the acid reaction of the aqueous buffered treatment solution with the mud cake provides time such that other drilling or completions operations finish before establishing flow-back from the treated site.

### BRIEF DESCRIPTION OF THE DRAWINGS

These and other features, aspects, and advantages of the present invention are better understood with regard to the following Detailed Description of the Preferred Embodiments, appended Claims, and accompanying Figures, where:

FIG. 1 is a graph showing a relationship between solubility and time for three solutions: A) A solution of formic acid precursor, B) A solution of formic acid precursor+2 wt. % potassium formate (“K-formate”) and C) A solution of formic acid precursor+4 wt. % potassium formate.

### DETAILED DESCRIPTION OF THE PREFERRED EMBODIMENTS

The Specification, which includes the Summary of Invention, Brief Description of the Drawings and the Detailed Description of the Preferred Embodiments, and the appended Claims refer to particular features (including process or method steps) of the invention. Those of skill in the art understand that the invention includes all possible combinations and uses of particular features described in the Specification. Those of skill in the art understand that the invention is not limited to or by the description of embodiments given in the Specification. The inventive subject matter is not restricted except only in the spirit of the Specification and appended Claims.

Those of skill in the art also understand that the terminology used for describing particular embodiments does not limit the scope or breadth of the invention. In interpreting the Specification and appended Claims, all terms should be interpreted in the broadest possible manner consistent with the context of each term. All technical and scientific terms used in the Specification and appended Claims have the same meaning as commonly understood by one of ordinary skill in the art to which this invention belongs unless defined otherwise.

As used in the Specification and appended Claims, the singular forms “a”, “an”, and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced. “Optionally” and its various forms means that the subsequently described event or circumstance may or may not occur. The description includes instances where the event or circumstance occurs and instances where it does not occur. “Operable” and its various forms means fit for its proper functioning and able to be used for its intended use. “Associated” and its various forms means something connected with something else because they occur together or that one produces the other.

Where the Specification or the appended Claims provide a range of values, it is understood that the interval encompasses each intervening value between the upper limit and the lower limit as well as the upper limit and the lower limit. The invention encompasses and bounds smaller ranges of the interval subject to any specific exclusion provided.

Where the Specification and appended Claims reference a method comprising two or more defined steps, the defined steps can be carried out in any order or simultaneously except where the context excludes that possibility.

### Aqueous Buffered Treatment Solution

The aqueous buffered treatment solution is a combination of the treating acid and the conjugate base of the treating acid in the base aqueous fluid. The aqueous buffered treatment solution is made by combining the acid precursor and the conjugate base salt in the base aqueous fluid to form the aqueous pre-buffer solution, where the conjugate base salt disassociates into the conjugate base upon dissolution. Inducing an elevated temperature in the aqueous pre-buffer solution converts the acid precursor into the treating acid and the aqueous pre-buffer solution into the aqueous buffered treatment solution.

An embodiment includes where the treating acid is a carboxylic acid. The treating acid is operable to react with the acid-reactive constituents of the water-based mud cake. The conjugate base delays the chemical reaction between the treating acid by forming a buffered treatment solution between the treating acid and the mud cake.

The aqueous pre-buffer solution converts into the aqueous buffered treatment solution at well bore conditions. Elevated temperatures in the aqueous pre-buffer solution fosters the generation of the treating acid from the acid precursor, which in turn also marks the point of conversion from the aqueous pre-buffer solution into the aqueous buffered treatment solution. Heating the aqueous pre-buffer solution to an excess of ambient conditions, for example at least 150° F., allows the acid precursor to convert into the treatment acid while in solution.

Suitable treatment acids include acids that form from the hydrolysis of an ester at the elevated temperature conditions of the well bore. Examples of such hydrolysis-formed acids include formic acids, acetic acids, propionic acids, lactic acids, butyric acids, isobutyric acids, malonic acids, succinic acids, malic acids, tartaric acids and citric acids. Combinations of the acids are also useful.

At the time of treatment acid formation, the conjugate base of the treating acid is present. In aqueous buffered treatment solution, the conjugate base forms almost instantaneously upon addition of conjugate base salt into the aqueous pre-buffer solution. The conjugate base is operable to buffer the treatment acid. The buffering effect between the treatment acid and the conjugate base of the treatment acid retards the interaction that the treatment acid has with the acid-reactive constituents in the mud cake, making the dissolution of the mud cake graduated such that the timing of flow-back is controlled and predictable.

### Aqueous Pre-Buffer Solution

The aqueous buffered treatment solution forms from the aqueous pre-buffer solution after exposure to elevated temperatures for a sufficient duration of time, where the acid precursor converts into the treatment acid. The base aqueous fluid dissolves both the acid precursor and conjugate base salt.

### Base Aqueous Fluid

The aqueous pre-buffer solution includes base aqueous fluid. The base aqueous fluid includes deionized, tap, distilled or fresh waters; natural, brackish and saturated salt waters; natural, salt dome petroleum production byproduct or synthetic brines; filtered or untreated seawaters; mineral waters; formation water; and other potable and non-potable waters containing one or more dissolved salts, minerals or organic materials.

The base aqueous fluid can originate from the hydrocarbon-bearing formation. “Formation water” is salty or briny water that emerges from the hydrocarbon-bearing formation with the hydrocarbons during the production of hydrocarbon fluids. Formation water often contains dissolved mineral and salts, including NaCl, CaCl₂, MgCl₂, CaSO₄, Na₂SO₄, MgBr₂, NaBr and KCl. After separation at the surface from the hydrocarbons, reintroduction of the formation water can carry the acid precursor and conjugate base salt to the treatment location.

### Acid Precursor

The aqueous pre-buffer solution includes the acid precursor of the treatment acid used for removal of mud cake at the treatment site. The acid precursor hydrolyzes into the treatment acid in the presence of water at elevated temperatures. An embodiment of the pre-buffer solution includes an acid precursor that is operable to disassociate into an alcohol and a carboxylic acid via hydrolysis at temperatures above standard conditions (>60° F.).

An example of a hydrolysis reaction is shown in Equation 1:

CH₃COOCH₂CH₃(aq.)+H₂O(l)<-->CH₃COOH(aq.)+CH₃CH₂OH(aq.) (Eq. 1).

Equation 1 shows the hydrolysis reaction (left to right) of ethyl ethanoate (an acid precursor) in water into ethanoic acid (a carboxylic acid) and ethanol (an alcohol).

Useful acid precursors include ester compounds, which are of the general formula shown in Equation 2:

R₁—COO—R₂ (Eq. 2),

where R₁ is ═H, phenyl, methoxy phenyl, alkyl phenyl, C1-30 alkyl, C1-30 substituted alkyl or a substituted phenyl; and
R₂=phenyl, methoxy phenyl, alkyl phenyl, C1-30 alkyl, C1-30 substituted alkyl, or a substituted phenyl. Diesters and triesters are also suitable. Preferred embodiments of the acid precursor include ethyl methanoate (ethyl formate), ethyl ethanoate (ethyl acetate), and ethyl 2-hydroxyproanoate (ethyl lactate) as the acid precursor. Other examples of useful esters include propyl formate, butyl formate, amyl formate, anisyl formate, methyl acetate, propyl acetate, tri-acetin, butyl propionate, isoamyl propionate, methyl butyrate, ethyl isobutyrate, butyl isobutyrate, diethyl malonate, butyl ethyl malonate, dimethyl succinate, diethyl succinate, diethyl malate, diethyl tartrate, dimethyl tartrate and triethyl citrate.

The aqueous pre-buffer solution is operable to generate in situ the aqueous buffered treatment solution. The hydrolysis reaction does not occur with water under standard conditions unless the reaction is acid-promoted. The hydrolysis reaction of the type shown in Equation 1 occurs more rapidly upon elevation of the aqueous pre-buffer solution temperature. The acid precursor is operable to convert into the treatment acid upon exposure to elevated temperatures (>60° F.) for a sufficient duration of time. It is preferred that the acid precursor does not convert into the treatment acid before exposure to the temperatures typical for downhole treatment side conditions.

### Conjugate Base Salt

The aqueous pre-buffer solution includes the conjugate base salt. The type of conjugate base salt is associated with the treatment acid that forms upon conversion of the aqueous pre-buffer solution into the aqueous buffered treatment solution.

To buffer the treatment acid in solution, the conjugate base salt disassociates and forms the conjugate base to the treatment acid and a free cation. The free cation usually is an associated alkali metals or alkaline earth metals, for example sodium and potassium.

Other examples of useful esters include propyl formate, butyl formate, amyl formate, anisyl formate, methyl acetate, propyl acetate, glycerin triacetate, butyl propionate, isoamyl propionate, methyl butyrate, ethyl isobutyrate, butyl isobutyrate, diethyl malonate, butyl ethyl malonate, dimethyl succinate, diethyl succinate, diethyl malate, diethyl tartrate, dimethyl tartrate and triethyl citrate.

The conjugate base is associated with the treatment acid. For example, if the treatment acid is acetic acid, which is a carboxylic acid, then the appropriate conjugate base formed from disassociation of the conjugate base salt is an acetate ion, which is a carboxylate ion. Suitable conjugate base salts that form acetate base ions for this example include potassium and sodium acetates. Useful conjugate base salts include sodium formate, sodium acetate, sodium lactate, potassium formate, potassium acetate and potassium lactate. Other useful conjugate base salts, depending on the treatment acid that forms, create base ions of formate, acetate, propionate, butyrate, isobutyrate, malonate, succinate, malate, tartate and citrates.

Incorporation of the conjugate base salt occurs as a solid or as a concentrated aqueous solution. The conjugate base salt disassociation preferably occurs upon immersion, but some conjugate base salts may require additional heating before full incorporation and disassociation. Regardless, incorporation and disassociation occurs before conversion of the aqueous pre-buffer solution into the aqueous buffered treatment solution.

### Molar Ratio Value and Treatment Delay Value

The molar ratio value, which is the molar concentration of acid precursor divided by the molar concentration of conjugate base salt in the aqueous pre-buffer solution correlates to the aggressiveness in which the acid buffered treatment solution reacts with and dissolves the acid-reactive constituents of mud cake at the treatment site. A molar ratio value of greater than 1 for an aqueous pre-buffer solution indicates that more acid precursor than conjugate base salt is present in the mixture. Upon conversion to the aqueous buffered treatment solution; more treatment acid forms than conjugate base is present. A molar ratio value of less than 1 produces the opposite state in both the aqueous pre-buffer solution and the aqueous buffered treatment solution.

Varying the relative amounts of the acid precursor to the conjugate base salt in the aqueous pre-buffer solution regulates the dissolution rate of mud cake. An embodiment of the aqueous pre-buffer solution includes a composition where the concentration of the acid precursor is at least twice as great as the concentration of the conjugate base salt.

Given all other things being equal, simultaneous introduction of a first aqueous pre-buffer solution having a molar ratio value of greater than 1 to a first treatment site and a second aqueous pre-buffer solution having a molar ratio value of less than 1 to a second treatment site results in achieving suitable dissolution faster at the first site versus the second site. One of ordinary skill in the art is capable of judging the amount of mud cake removal that is appropriate for determining what is “suitable dissolution” either for laboratory analysis or for fluid production in the field.

The treatment delay value for an aqueous pre-buffer solution is the amount of time starting from the time of introduction of the aqueous pre-buffer solution to the treatment site to the time of achieving flow-back from the treatment site. Expression of the treatment delay value for a particular aqueous pre-buffer solution is a value of time from introduction (that is, minutes, hours, portions of days and days) or a range of time values (for example, 3.0-3.5 days).

The molar ratio value is the main factor from which the relative treatment delay value between two compositions having similar conjugate base salt and acid precursor pairs, this may not hold true for two different aqueous pre-buffer solutions where the conjugate base salt and acid precursor pairs are different. An aqueous pre-buffer solution with a low molar ratio value forming a strong treatment acid may have a shorter treatment delay value versus an aqueous pre-buffer solution with a high molar ratio value that forms a weak treatment acid.

Actual conditions or theoretically relationships can help determine the treatment delay value for a particular aqueous pre-buffer solution. Knowledge associated with laboratory and field experimentation; prior use in the field; theoretical reaction rates between the treatment acid and reactive constituents in the mud cake; disassociation values for the conjugate base salt and the acid precursor in the aqueous pre-buffer solution; downhole conditions, including downhole temperature and the presence of formation fluids; heat capacity of the aqueous pre-buffer solution; compositional analysis of the mud cake and fluids at the treatment site; and the buffering relationship between the conjugate base and the treatment acid all contribute to the determination of the treatment delay value for the aqueous pre-buffer solution. The treatment delay value can be as short as a few hours to as long as a few days. Lengthening or shortening the treatment delay value is feasible by addition conjugate base salt or acid precursor to a pre-made aqueous pre-buffer solution. Manipulation of the concentration of the base aqueous fluid can also affect the treatment delay value.

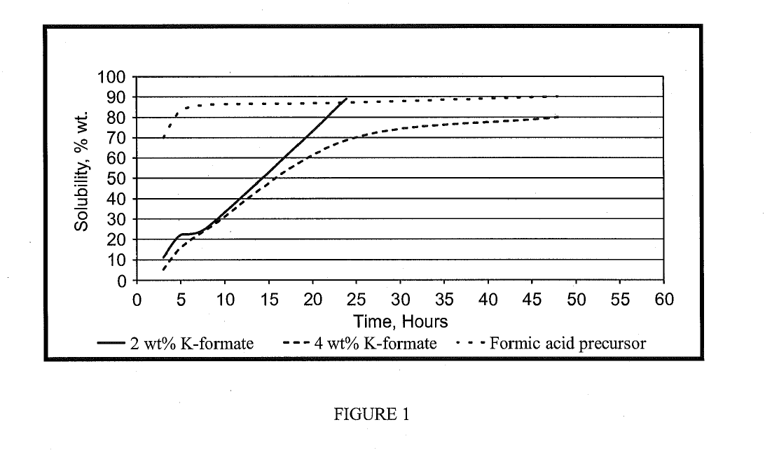

### FIG. 1

FIG. 1 is a graph of solubility versus time for three aqueous compositions: an aqueous composition only containing a precursor of formic acid, an aqueous pre-buffer solution composition containing a formic acid precursor and 2 weight percent (wt. %) potassium formate (“K-formate”), and an aqueous pre-buffer solution composition containing formic acid precursor and 4 wt. % potassium formate. Potassium formate is the conjugate base salt of the formic acid precursor.

The solubility tests occur in glass bottles. At a 10:1 liquid:solid ratio, a known amount of each of the three aqueous compositions mixes with the mudcake or calcium carbonate. Filtering and weighing the solids at designated times indicates the amount of weight loss for the mudcake, indicating solubility.

As seen in FIG. 1, the aqueous solution containing formic acid precursor solubilizes most of the material only several hours after introduction. The formic acid hydrolyzes into formic acid, and the unbuffered acid quickly reacts and solubilizes the test material. A portion of the conjugate base salt postassium formate tempers in the rate of dissolution of the test material in the other two solutions. The 2 wt. % potassium formate solution appears to take a little less than 15 hours (but more than 10 hours) to solubilize 50 wt. % of the test material and a little less than 20 hours (but more than 15 hours) to solubilize 70 wt. % of the test material. The 4 wt. % potassium formate solution appears to take a little more than 15 hours to solubilize 50 wt. % of the test material and about 25 hours to solubilize 70 wt. % of the test material. The small change in the amount of buffering conjugate base salt in the aqueous pre-buffer solution has an apparent impact upon the rate of solubilization of the treatment acid.

### Method for Removing Mud Cake

Using aqueous pre-buffer solutions with different treatment delay values can assist in coordinating different treatment sites within a well bore. The method for removing mud cake from a treatment site in a well bore using the aqueous buffered treatment solution depends on several factors. The mud cake composition includes acid-reactive constituents susceptible to acid degradation such that treatment establishes flow-back from the hydrocarbon-bearing formation at the treatment site. The well bore at the treatment site is operable to induce an elevated temperature in the introduced aqueous pre-buffer solution

The method for removing mud cake includes the step of introducing the aqueous pre-buffer solution to the treatment site. The introduction is such that the introduced aqueous pre-buffer solution contacts the mud cake at the treatment site. Well known and appreciate means as previously described introduce the aqueous pre-buffer solution to the treatment site using fluid conduits, including coiled tubing and drill string. An embodiment includes providing sufficient aqueous pre-buffer solution such that the aqueous pre-buffer solution immerses the mud cake and they are in continuous contact. The aqueous pre-buffer solution includes the acid precursor and the conjugate base salt in the base aqueous fluid. An embodiment includes where the acid precursor is a precursor for forming a treatment acid that is a carboxylic acid.

An embodiment includes introducing the aqueous pre-buffer solution to the treatment site using a fluid conduit where the aqueous pre-buffer solution forms at the surface. The fluid conduit can include coiled tubing or drill pipe. An embodiment includes introducing the aqueous pre-buffer solution to the treatment site by introducing separately a solution or solid conjugate base salt, the acid precursor, and the base aqueous fluid to the treatment side, thereby forming the aqueous pre-buffer solution at the treatment site. An embodiment includes introducing the aqueous pre-buffer solution to the treatment site by introducing a solution or solid conjugate base salt and the acid precursor to the base aqueous fluid at the treatment site. The base aqueous fluid present at the treatment site can be formation water. In such instances, introduction of a water-soluble package introduces dry or powdered forms of the acid precursor and the conjugate base salt into the water or brine present at the treatment site, forming the aqueous pre-buffer solution. Preferably, in instances where introduction of the aqueous pre-buffer solution components occurs separately, introduce the conjugate base salt before the acid precursor allows the formation of the conjugate base before introduction and formation of the treatment acid.

Upon introduction to the treatment site in the well bore (if not before), the conjugate base forms via disassociation of the conjugate base salt in the aqueous pre-buffer solution. Also upon introduction, the well bore induces an elevated temperature in the aqueous pre-buffer solution. Although initially cooling the treatment site upon introduction, the native temperature of the well bore environment eventually imparts thermal energy into the aqueous pre-buffer solution. The well bore temperature is significantly higher (>150° F.) than surface ambient conditions. The elevated temperature in the aqueous pre-buffer solution induces the acid precursor to convert into the treatment acid, changing aqueous pre-buffer solution into the aqueous buffered treatment solution.

The conjugate base in the aqueous buffered treatment solution retards the interaction that the treatment acid has with the acid-reactive constituents in the mud cake such that not all of the treatment acid interacts with the acid-reactive constituents instantly upon formation. The treatment acid reaction with the acid-reactive constituents in the mud cake can occur over a period of minutes to days. Gradually, the treatment acid chemically degrades the mud cake such that a sufficient level of flow-back occurs from the hydrocarbon-bearing formation at the treatment site.

Method for Removing Mud Cake from Multiple Treatment Sites in a Multilateral Well Bore

The method for removing mud cake from more than one treatment site in a well bore using aqueous buffered treatment solution depends on several factors. The mud cake composition includes acid-reactive constituents. Degradation of the mud cake at each site establishes flow-back from the hydrocarbon-bearing formation at that site. The well bore at each treatment site is operable to induce an elevated temperature in the introduced aqueous pre-buffer solution. An embodiment includes where the well bore temperature is different at each treatment site.

Where multiple treatment sites contain mud cake, including in a single or multilateral well, several options exist to induce flow-back at an appropriate time. An embodiment includes introducing an aqueous pre-buffer solution to more than one treatment site simultaneously. By using more than one fluid conduit routed to the several sites for treatment, the introduction of aqueous pre-buffer solution to each site simultaneously can occur. Although feasible, this is in practice very difficult and not very practical, especially when there are more than two sites to treat simultaneously. The number of coiled tubing connections and routing of the coiled tubing is difficult enough.

Instead, introducing different aqueous pre-buffer solutions to the different treatment sites using a single means for introducing the various aqueous pre-buffer solutions is much easier to plan and execute. Using more than one aqueous pre-buffer solution with different molar ratio values or treatment delay values can help establish flow-back from all the treated sites such that all the flow occurs after a future point in time or during a designated time interval. Coordinated introduction of different aqueous pre-buffer solutions to the various treatment sites can ensure that flow-back from the well bore does not prematurely occur at any treatment site. Premature flow-back from one treatment site within the well bore can flood the rest of the well bore and disrupt treatment at the other sites, causing only partial production from the hydrocarbon-bearing formation.

The method includes using a first aqueous pre-buffer solution with a first acid precursor and a first conjugate base salt for a first treatment site and a second aqueous pre-buffer solution with a second acid precursor and a second conjugate base salt for a second treatment site. Upon achieving an elevated temperature at the treatment site, the first aqueous pre-buffer solution at the first treatment site converts into the first aqueous buffered treatment solution, which has a first treatment acid and a first conjugate base for the treatment acid. As well, the second aqueous pre-buffer solution converts into the second aqueous buffered treatment solution, which has a second treatment acid and a second conjugate base for the treatment acid. If either the first or the second acid precursor is an ether, the disassociation of the acid precursor can form a carboxylic acid as the treatment acid. It also produces an alcohol by-product.

An embodiment includes where the first acid precursor and the second acid precursor are not the same. An embodiment includes where the disassociation of the first acid precursor produces a first alcohol and the disassociation of the second acid precursor produces a second alcohol, where the first alcohol and the second alcohol are not the same. An embodiment includes where the first conjugate base salt and second conjugate base salt are not the same. An embodiment includes where the first treatment acid and the second treatment acid are not the same. An embodiment includes where the first treatment acid is a carboxylic acid. An embodiment includes where the second treatment acid is a carboxylic acid different from the first carboxylic acid. An embodiment includes where the first conjugate base and the second conjugate base are not the same. An embodiment includes where the molar ratio value of the first aqueous pre-buffer solution and the molar ratio value of the second aqueous pre-buffer solution are not the same. An embodiment includes where the molar ratio value of the first aqueous pre-buffer solution and the molar ratio value of the second aqueous pre-buffer solution are not the same.

An embodiment includes coordinating the introduction of each aqueous pre-buffer solution such that the combination of the time of introduction and the treatment delay value for each aqueous pre-buffer solution ensures that establishment of flow-back at each treatment site does not occur until after a future point in time. An embodiment includes coordinating the introduction of each aqueous pre-buffer solution such that the combination of introduction and the treatment delay value for each aqueous pre-buffer solution ensures that the establishment of flow-back at each treatment site does not occur until a future time interval.

What is claimed is:

1. A method for removing a portion of mud cake from a treatment site in a well bore servicing a hydrocarbon-bearing formation, the method for removing a portion of mud cake comprising the step of:
combining an acid precursor operable to undergo hydrolysis into a treatment acid at an elevated temperature, a conjugate base salt operable to disassociate into a conjugate base for the treatment acid, and a base aqueous fluid to form an aqueous pre-buffer solution, the aqueous pre-buffer solution having a molar value ratio and a treatment delay value; and
introducing the aqueous pre-buffer solution to the treatment site in the well bore servicing the hydrocarbon-bearing formation such that the pre-buffer solution fluidly contacts the mud cake,
where the hydrocarbon-bearing formation induces an elevated temperature in the introduced aqueous pre-buffer solution such that the acid precursor undergoes hydrolysis into the treatment acid, forming the aqueous buffered treatment solution, and
where the reaction between the treatment acid of the aqueous buffered treatment solution and the acid-reactive constituents in the mud cake removes a portion of the mud cake.

2. The method of claim 1 where the aqueous pre-buffer solution is introduced such that the treatment site is fully immersed in the aqueous pre-buffer solution.

3. The method of claim 1 where the acid precursor of the aqueous pre-buffer solution is operable to form a carboxylic acid upon hydrolysis and where the conjugate base salt is operable to form a carboxylate ion for the carboxylic acid.

4. The method of claim 1 where the aqueous buffered treatment solution removes at least about 50 weight percent of the mud cake at the treatment site in no less than about 10 hours after introduction of the aqueous pre-buffer solution to the treatment site.

5. The method of claim 1 where the removal of the portion of mud cake establishes flow-back from the treatment site and where the introduction of the aqueous pre-buffer solution occurs at a time of introduction such that flow-back does not occur until after a future point in time.

6. The method of claim 1 where the removal of the portion of mud cake establishes flow-back from the treatment site and where the introduction of the aqueous pre-buffer solution occurs at a time of introduction such that flow-back occurs during a future time interval.

7. The method of claim 1 where the acid precursor is selected from the group consisting of ethyl methanoate, ethyl ethanoate, ethyl 2-hydroxyproanoate, and combinations thereof.

8. The method of claim 1 where the conjugate base salt is selected from the group consisting of sodium and potassium salts of the conjugate base for the treatment acid.

9. The method of claim 1 where the acid precursor is ethyl formate and the conjugate base salt is potassium formate.

10. The method of claim 1 where the treatment delay value is greater than about 10 hours.

11. The method of claim 1 where the concentration of the acid precursor is at least twice that of the concentration of the conjugate base salt in the aqueous pre-buffer solution.

12. A method of establishing flow-back from more than one treatment site in a well bore servicing a hydrocarbon-bearing formation, the method for removing a portion of mud cake comprising the steps of:
combining a first acid precursor operable to undergo hydrolysis into a first treatment acid at an elevated temperature, a first conjugate base salt operable to disassociate into a first conjugate base for the first treatment acid, and a first base aqueous fluid to form the first aqueous pre-buffer solution, the first aqueous pre-buffer solution has a first molar value ratio and a first treatment delay value;
introducing the first aqueous pre-buffer solution to the first treatment site in the well bore servicing the hydrocarbon-bearing formation such that the first pre-buffer solution fluidly contacts the mud cake at the first treatment site, and
combining a second acid precursor operable to undergo hydrolysis into a second treatment acid at an elevated temperature, a second conjugate base salt operable to disassociate into a second conjugate base for the second treatment acid, and a second base aqueous fluid to form the second aqueous pre-buffer solution, the second aqueous pre-buffer solution has a second molar value ratio and a second treatment delay value;
introducing the second aqueous pre-buffer solution to the second treatment site in the well bore servicing the hydrocarbon-bearing formation such that the second pre-buffer solution fluidly contacts the mud cake at the second treatment site,
where the time of introduction for the first and second aqueous pre-buffer solutions is not the same,
where the hydrocarbon-bearing formation induces an elevated temperature in the introduced first aqueous pre-buffer solution such that the first acid precursor undergoes hydrolysis into the first treatment acid, forming the first aqueous buffered treatment solution,
where the hydrocarbon-bearing formation induces an elevated temperature in the introduced second aqueous pre-buffer solution such that the second acid precursor undergoes hydrolysis into the second treatment acid, forming the second aqueous buffered treatment solution,
where the reaction between the first treatment acid of the first aqueous buffered treatment solution and the acid-reactive constituents in the mud cake at the first treatment site establishes flow-back from the first treatment site, and
where the reaction between the second treatment acid of the second aqueous buffered treatment solution and the acid-reactive constituents in the mud cake at the second treatment site establishes flow-back from the second treatment site.

13. The method of claim 12 where the introduction of the first aqueous pre-buffer solution occurs at a first point in time, the introduction of the second aqueous pre-buffer solution occurs at a second point in time, where the first point in time is earlier in time than the second point in time, and where flow-back is established at both the first and second treatment sites after a future point in time.

14. The method of claim 12 where the introduction of the first aqueous pre-buffer solution occurs at a first point in time, the introduction of the second aqueous pre-buffer solution occurs at a second point in time, where the first point in time is earlier in time than the second point in time, and where flow-back is established at both the first and second treatment sites during a future time interval.

15. The method of claim 12 where the first acid precursor and the second acid precursor are not the same.

16. The method of claim 12 where the first conjugate base salt and second conjugate base salt are not the same.

17. The method of claim 12 where the first treatment acid and the second treatment acid are not the same.

18. The method of claim 12 where the first treatment acid is a carboxylic acid.

19. The method of claim 12 where the second treatment acid is a carboxylic acid.

20. The method of claim 12 where the hydrolysis of the first acid precursor forms a first alcohol, the hydrolysis of the second acid precursor forms a second alcohol, and where the first and second alcohols are not the same.

21. The method of claim 12 where the first and second conjugate bases are not the same.

22. The method of claim 12 where the treatment delay value for the first aqueous pre-buffer solution and the treatment delay value for the second aqueous pre-buffer solution are not the same.

23. The method of claim 12 where the molar ratio value of the first aqueous pre-buffer solution and the molar ratio value of the second aqueous pre-buffer solution are not the same.

24. An aqueous buffered treatment solution useful for removing mud cake, the aqueous buffered treatment solution made by:
combining an acid precursor operable to undergo hydrolysis into a treatment acid at an elevated temperature, a conjugate base salt operable to disassociate into a conjugate base for the treatment acid, and a base aqueous fluid to form an aqueous pre-buffer solution; and
inducing an elevated temperature in the aqueous pre-buffer solution such that the acid precursor undergoes hydrolysis and forms the treatment acid, forming the aqueous buffered treatment solution.

25. The aqueous buffered treatment solution of claim 24 where the treatment acid is a carboxylic acid and the conjugate base is a carboxylate ion for the treatment acid.

26. The aqueous buffered treatment solution of claim 24 where the treatment acid is a formic acid and the conjugate base is a formate base.

27. The aqueous buffered treatment solution of claim 24 where the acid precursor is ethyl formate and the conjugate base salt is potassium formate.

28. The aqueous buffered treatment solution of claim 24 where the amount of conjugate base salt is in a range of from about 2 weight percent to about 4 weight percent of the total weight of the aqueous pre-buffer solution.

29. The aqueous buffered treatment solution of claim 24 where the base aqueous fluid is selected from the group consisting of natural and artificial brines, seawaters, formation water and combinations thereof.

30. The aqueous buffered treatment solution of claim 24 where the elevated temperature is greater than about 150° F.

31. The aqueous buffered treatment solution of claim 24 where the combining step occurs in the well bore of a hydrocarbon-bearing formation.

32. The aqueous buffered treatment solution of claim 24 where the aqueous buffered treatment solution is operable to remove at least about 50 weight percent of a mud cake at a treatment site in a well bore servicing a hydrocarbon-bearing formation in no less than about 10 hours after introduction into a well bore.

33. An aqueous pre-buffer solution useful for removing mud cake, the aqueous pre-buffer solution made by combining an acid precursor operable to undergo hydrolysis into a treatment acid at an elevated temperature, a conjugate base salt operable to disassociate into a conjugate base for the treatment acid, and a base aqueous fluid, where upon inducing an elevated temperature such that the acid precursor undergoes hydrolysis and forms a treatment acid the aqueous pre-buffer solution forms an aqueous buffered treatment solution.

34. The aqueous pre-buffer solution of claim 33 where the acid precursor is operable to form a carboxylic acid upon hydrolysis and where the conjugate base salt is operable to form a carboxylate ion for the carboxylic acid.

35. The aqueous pre-buffer solution of claim 33 where the acid precursor is selected from the group consisting of ethyl methanoate, ethyl ethanoate, ethyl 2-hydroxyproanoate, and combinations thereof.

36. The aqueous pre-buffer solution of claim 33 where the conjugate base salt is selected from the group consisting of sodium and potassium salts of the conjugate base for the treatment acid.

37. The aqueous pre-buffer solution of claim 33 where the acid precursor is ethyl formate and the conjugate base salt is potassium formate.

38. The aqueous pre-buffer solution of claim 33 where the amount of conjugate base salt is in a range of from about 2 weight percent to about 4 weight percent of the total weight of the aqueous pre-buffer solution.

39. The aqueous pre-buffer solution of claim 33 where the concentration of the acid precursor is at least twice that of the concentration of the conjugate base salt.
